(19) United States
(12) Patent Application Publication
(10) Pub. No.: US 2009/0264575 A1
(43) Pub. Date: Oct. 22, 2009

(54) Metal pigments comprising a cross-linkable binding agent coating, coating composition, method for the production of coated metal pigments and use thereof

(76) Inventors: Frank Henglein, Nurnberg (DE); Burkhard Schreiber, Hersbruck (DE); Alexander Albrecht, Nurnberg (DE)

Correspondence Address: OSTROLENK FABER GERB & SOFFEN, 1180 AVENUE OF THE AMERICAS, NEW YORK, NY, 100368403, US

(21) Appl. No.: 10/584,691

(22) PCT Filed: Dec. 23, 2004
(86) PCT No.: PCT/EP2004/014663

§ 371 Date: May 22, 2007

(30) Foreign Application Priority Data
Dec. 23, 2003 (DE) 103 61 437.0

(51) Int. Cl. C08K 3/08; B05D 7/16; C08L 67/00

(52) U.S. Cl. 524/441; 427/216; 524/539

(57) ABSTRACT

The invention relates to metal pigments comprising a coating. The coating surrounds the metal pigments and comprises cross-linkable oligomer and/or polymer binding agent(s) which are chemically cross-linkable and/or active under the influence of heat, IR radiation, UV radiation and/or electron radiation. The coated metal pigments are embodied in the form of powder, which has a particle size d₅₀ of less than 190 μm, and are resistant to corrosion after hardening in a coating powder. The invention further relates to a coating composition, to a method for the production of the coated metal pigments, in addition to the use thereof.

The present invention relates to the provision of coated metallic pigments, to a coating composition, to a process for the production of said coated metallic pigments, and to the use thereof.

Metallic pigments are widely used for the pigmentation of paints, varnishes, powder-based varnishes, printing inks, plastics materials, or cosmetics. The incorporation and wetting of these pigments in binding agent systems often presents problems, particularly in the case of powder-based varnishes.

Unlike organic or inorganic colored pigments, metallic pigments cannot be incorporated in powder-based varnishes by means of extrusion and subsequent comminution of the extrudate, as doing so would cause the flake-like pigments to be broken and lose their optical effects. Instead, so-called dry blend or bonding methods are used.

A dry blend method is to be understood as being a simple mixing process, wherein powder-based varnish components such as binding agents, additives, etc, and the metallic pigments are dry mixed with each other. The disadvantage of these methods is that the metallic pigment and the binding agent separate in such dry mixtures during coating of the powder-based varnish on account of, inter alia, their differences in specific gravity and electrostatic charging behavior. Recyclability of the powder-based varnish, which is basically one of the major advantages of powder-based varnish systems, is no longer possible in powder-based varnishes pigmented with metallic pigments that have been manufactured by this method.

A bonding method is to be understood as being a mixing process of a powder-based varnish and a metallic pigment in which the metallic pigment particles are physically bonded to the powder-based varnish particles by heating the mixture to the glass transition temperature of the powder-based varnish. Adhesion of the metallic pigments to the surface of the powder-based varnish particles is therefore achieved when using the bonding method.

The disadvantage of both the dry blend and the bonding methods is that the metallic pigments are not enveloped by the binding agent and consequently they are applied to a substrate without being enveloped by a binding agent. In the subsequent curing process, which is generally a stoving process, these pigments are not completely covered with the binding agent. After the powder-based varnish has been cured, the metallic pigments are consequently not completely enveloped by the binding agent and thus the corrosion stability is less than optimal.

Corrosion stability is particularly critical for metallic pigments that are located on or near the surface of a powder coating. With powder-based varnish applications in particular, in practice metallic pigments showing a leafing behavior are present to some degree even in metallic pigments intrinsically showing a non-leafing behavior. These pigment particles are exposed to particularly intense corrosive influences of the environment and mechanical stress. In these cases, a thin or inadequate coating with the cured binding agent has particularly serious effects. A major disadvantage of such an inadequate coating is that the desired visual effect is impaired to a high degree. Furthermore, powder-based varnish coatings are mostly single layer coatings, so that the protecting effect of a clear varnish is lacking. Particularly in the case of outdoor applications, however, very high demands are placed on metallic pigments with regard to effect consistency and corrosion stability.

To improve the application technology properties or to protect the pigments from corrosion, metallic pigments can be enhanced by various preparative steps prior to being incorporated in varnish systems. Such steps include chemical processes which impart a more or less uniform coating to the pigment surface. Organic or inorganic coatings may be used for this purpose.

U.S. Pat. No. 4,434,009 describes the coating of a metallic pigment with a polymer. The coating is synthesized from monomers that have a polymerizable double bond and an epoxy group.

Another polymer coating of metallic pigments is described in JP 56-161470. Said coating is formed from styrene, (meth)acrylonitrile, or (meth)acrylic acid monomers.

Similar polymer coated metallic pigments are described in the German Laid-open Application DE 25 26 093.

Synthetic resin metallic pigment coatings are described in EP 0 280 749. Initially, these coatings comprise an adhesive agent layer having at least one ethylenically unsaturated double bond. Next follows a polymeric synthetic resin, which is synthesized from monomers having at least three ethylenically unsaturated bonds. The chemical variability of the monomers used in EP 0 280 749 is limited to a high degree. Ethylenically tri-unsaturated monomers produce highly cross-linked polymeric protective layers from which; however, no varnish can be synthesized. Such polymeric layers would be too brittle for the synthesis of varnishes. Monomers capable of triple cross-linking or an even higher degree of cross-linking are used as cross-linking agents in varnishes only in quantities ranging up to 3% by weight, and in no case are entire polymeric layers synthesized therefrom.

Similarly, DE 40 30 727 or EP 0 477 433 describes a metallic pigment coating produced from a three dimensionally cross-linked plastic coating, which coating is covalently bonded to a siloxane layer predeposited on the pigment. Protected pigments suitable for use in water-based varnishes are thus obtained. According to the teaching of these two patents, adhesives must be applied to the surfaces of the metal flakes prior to the actual plastic resin coating, as otherwise it is not possible to achieve an effective coating.

A factor common to all of these polymer coatings known in the prior art is that they are manufactured exclusively from monomers. These monomers are mostly polymerized by free-radical polymerization in the presence of metallic pigments dispersed in a solvent.

Furthermore, surface modifications produced by the deposition of surfactants onto the pigment can improve the wetting thereof and bonding thereof to a binding agent (EP 1 084 198).

Moreover, methods can be used for powder-based varnishes in particular wherein the surface of the powder-based varnish particles is coated with colored pigments or metallic pigments (DE 100 58 860 A1). The disadvantage of these methods is that the metallic pigments adhere to the surface of the particles of the powder-based varnish and, as explained above, are not enveloped by the powder-based varnish or not bonded to the powder-based varnish, which ultimately leads to the metallic pigments corroding after they have been applied.

WO 98/37 154 discloses a process for the manufacture of powder-based varnishes containing glossy pigments wherein a supercritical fluid is used. This method is very expensive and requires elaborate equipment. In this process, the glossy pigment particles are distributed within the powdered pigment granules. The disadvantage thereof is that the individual pigments are not effectively coated. With metallic pigments, this leads to corrosion problems during storage and after application.

A powder-based varnish is disclosed in WO 98/46682, wherein the powder-based varnish particles adhere to an adhesive metallic pigment surface. One disadvantage of this method is that the powder-based varnish is not effectively and evenly bonded to the adhesive metallic pigment surfaces. This uneven adhesion of the powder-based varnish particles results in uneven varnish surfaces when the varnish is applied. Also, the metallic pigment particles agglomerate and/or aggregate readily in the powder-based varnish on account of the adhesive metallic pigment surfaces. Furthermore, the metallic pigments are not effectively enveloped by a coating. Consequently, these metallic pigments are not corrosion stable.

In the pigment coatings known in the prior art, the resulting metallic pigments are either provided with inorganic or cross-linked polymeric layers that no longer take part in the cross-linking reactions with typical powder-based varnish or typical wet varnish binding agents and/or curing agents. They cannot therefore be bonded in the plastic matrix, and the pigments are not sufficiently corrosion stabilized.

It is therefore an object of the present invention to provide a metallic pigment which has a high degree of chemical and physical durability imparted by a highly effective coating, and which can be readily incorporated in an application medium. Examples of areas of application are critical applications in particular, such as facade coatings, which as a rule are exposed without protection to the entire range of environmental influences, and which must withstand exceptionally long periods of use.

Furthermore, an improved recyclability of the metallic pigmented powder-based varnish is desirable in the recovery unit in the coating cabinet.

Additionally, it is desirable that such a metallic pigment be a low-dust, free-flowing powder. It is also desirable that universal applicability thereof in diverse powder-based varnish systems and liquid varnish systems be assured.

The provision of a high-output, cost-effective process for the manufacture of such metallic pigments is another object of the invention. The process should be simple and assure gentle treatment of the metallic pigments.

The object of the invention is achieved by the provision of coated metallic pigments wherein the coating envelops the metallic pigments and comprises one or more than one cross-linkable oligomeric and/or polymeric bonding agent that can be cross-linked chemically and/or by heat, IR radiation, UV radiation, and/or electron radiation, wherein the coated metallic pigments are present as a powder having a mean particle size d₅₀ of less than 190 μm, and are corrosion stable in a powder-based varnish after they have been cured.

Preferred developments are defined in the subordinate claims.

The object of the invention is also achieved by the provision of a master batch for powder-based varnishes and wet varnishes, wherein said master batch contains metallic pigments according to any one of claims 1 to 25.

Advantageously, the binding agents used to envelop the metallic pigment are the same as those used as binding agents in a powder-based varnish. The binding agents of the invention are therefore suitable as a master batch or concentrate for the manufacture of a powder-based varnish containing a metallic pigment.

A smooth varnish layer in which the metallic pigments are chemically bonded after the powder-based varnish has been applied and cured is achieved by using the same binding agents for coating the metallic pigments of the invention and for the powder-based varnish. Such varnish layers have an exceptionally fine appearance and are corrosion stable.

The object of the invention is also achieved by the provision of a coating composition, wherein the coating composition contains metallic pigments according to any one of claims 1 to 26, and wherein the metallic pigments are corrosion stable after the coating composition has cured.

Preferred embodiments are given in the subordinate claims.

Furthermore, the object of the invention is achieved by the provision of a coated object, wherein the object is coated with metallic pigments according to any one of claims 1 to 26, or with a coating composition according to any one of claims 28 to 32.

The coated object is preferably an object that is subjected to corrosive environmental conditions, for example, natural weather conditions. This object is, say, a facade element such as a facade tile, a window frame, a vehicle body such as the body of a motor vehicle, or the frame of a vehicle such as a bicycle or a motorcycle.

The object of the invention is also achieved by the use of the metallic pigment according to any one of claims 1 to 25 in paints, varnishes, powder-based varnishes, printing inks, plastics materials, or fingernail varnishes.

The object of the invention is also achieved by the provision of a fingernail varnish, wherein this cosmetic contains metallic pigments according to any one of claims 1 to 26.

Thus the metallic pigments of the invention have an enveloping coating composed of cross-linkable binding agents in their oligomeric or polymeric base form. According to their respective chemical nature, the binding agents can polymerize under the influence of heat, IR, UV and/or electron irradiation, or also by reacting with a suitable curing agent after the envelopment of the metallic pigment, so that the metallic pigments become embedded in a polymeric film. Such complete envelopment substantially improves the abrasion and chemical stability of the metallic pigment. The weathering stabilities achieved in this manner cannot be achieved with traditional metallic pigments.

Within the scope of the invention, “corrosion stable” is to be understood as meaning that the optical appearance of the metallic pigments, after incorporation in a powder-based varnish and after the application of, and curing of, this powder-based varnish, is not impaired, or only insignificantly impaired, after a long period of time, say, months and years. As a measurement of corrosion stability, the mortar test in particular, according to the GSB [Gütegemeinschaft für die Stückbeschichtung von Bauteilen e.V. (Quality Association for Piece Coating of Structural Elements)] stipulations described in the examples, can be used. Passing this very stringent corrosion test is a prerequisite for using metallic pigmented powder-based varnishes on facade elements. Passing the mortar test, as described in more detail further below, is indicative of corrosion stability within the scope of the invention.

The coated metallic pigments of the invention are preferably low-dust, free-flowing powders that can also be made into a paste with solvents such as organic solvents and/or water. The metallic pigments of the invention are thus distinguished by a high degree of flexibility in application.

Within the scope of the invention, metallic pigments are to be understood as flake-like metallic effect pigments. These pigments have a form factor, i.e., a ratio of their longitudinal extent to their mean thickness, that is greater than 10, preferably greater than 20 and more preferably greater than 50. More preference is given to a form factor ranging from 50 to 1000, and even more preference to one ranging from 100 to 200. The longitudinal extent is to be understood here as the d₅₀ value of the cumulative breakthrough curve, as measured by standard laser granulometry methods. The d₅₀ values of the longitudinal extents range from 2 μm to 150 μm, preferably from 3 μm to 75 μm and very preferably from 5 μm to 60 μm.

With powder-based varnish applications, there is an outstanding recyclability of the metallic pigmented powder-based varnish. The portion of the powder-based varnish which is not cured on the substrate, in which the metallic pigment of the invention is present, can be advantageously recycled and re-sprayed in the next powder-based varnish application.

Within the scope of the invention, a binding agent is to be understood under the definition given in DIN 55 945. That is, the binding agent includes the film former as well as non-volatile agents such as plasticizers and exsiccants.

As a rule, the binding agents are present as oligomers and/or polymers having a low molecular weight. The molecular weight preferably ranges from 200 g/mol to 10,000 g/mol and more preferably from 500 g/mol to 8,000 g/mol. The low molecular weights of the oligomers and/or polymers used make it possible to impart certain viscosities that cannot be imparted with either dissolved monomeric components or with high molecular weight components (see P. Nanetti, Coatings Compendien, Lackrohstoffkunde“ p. 17 ff., Vincentz Verlag 2000). For the sake of simplicity, the oligomeric and/or polymeric binding agents used in the present invention will be referred to below simply as “binding agents”.

Curing agents are generally present in monomeric form. The initially thermoplastic binding agents, or binding agents and possibly a curing agent, react with each other under suitable conditions such as, say, an elevated temperature, to form a thermosetting material. Polymerizations and, if curing agents are used, polycondensation or even polyadditions can occur at this point.

This substantially differentiates the coating of the metallic pigments of the invention from the polymer coatings known in the prior art. The binding agents are still curable or polymerizable after the metallic pigments have been coated therewith. During the coating process accompanied by the evaporation of the solvent, the binding agents may begin to polymerize very slightly, but will not cure to completion. On the other hand, the synthetic coatings of metallic pigments known in the prior art are formed from monomers that react substantially quantitatively to form a polymeric film on the pigment surface. These for the most part cured polymers are no longer reactive.

The metallic pigments of the invention thus have a reactive binding agent coating that specifically allows a reaction with the binding agent of, say, a varnish or a printing ink, after the metallic pigment of the invention has been applied. The coating of the coated metallic pigments in which the binding agents are present can then cure after the application, without cross-linking with the binding agent of the application medium, for example, a varnish or a printing ink. This may occur on account of chemical incompatibilities between the binding agent of the application medium and the binding agent-containing coating.

Preference is given to a binding agent or binding agents selected from the group of standard binding agents used in powder-based varnishes, for example
polyesters containing carboxyl groups, preference being given to saturated polyesters containing carboxyl groups. These are reactive compounds having an acid value of preferably from 5 mg to 100 mg of KOH/g and more preferably from 20 mg to 70 mg of KOH/g. These resins may have been optimized, in combination with the appropriate curing agent, for corrosion stabilities required for outdoor applications as well as for the less critical indoor applications. Typical resins are Crylcoat 340 and Crylcoat 632 supplied by UCB, Belgium, www.ucb.de or Uralac P2200 supplied by DSM, the Netherlands, www.dsm.com,
polyesters containing hydroxyl groups, wherein preference is given to saturated polyesters containing hydroxyl groups. The hydroxyl value preferably ranges from 120 mg to 15 mg of KOH/g and more preferably from 50 mg to 30 mg of KOH/g. Typical resins are Crylcoat E5169 supplied by UCB, Belgium,
the so-called dual cure resins registered under the name of Uranox and supplied by DSM, the Netherlands.
preferably epoxide resins typically used in powder-based varnishes and having an epoxy equivalent weight preferably ranging from 175 to 6000 and more preferably from 450 to 4000.
preferably acrylate resins typically used in powder-based varnishes and functionalized acrylate resins having, for example, hydroxy functions, carboxy functions, or epoxy functions (for example, those supplied by Mitsui Tuatzo, Japan).
preferably radiation-cured resins typically used in powder-based varnishes, for example unsaturated acrylates, such as epoxy acrylates, urethane acrylates, polyester acrylates, polyether acrylates, and mixtures thereof. An example is UVECOAT 3001 supplied by UCB, Belgium,
silane-based, highly heat stabilized binding agents, for example, the Silres resins supplied by Wacker, Germany,
functionalized resins such as epoxide resins, polyester resins, preference being given to functionalization with phosphoric acid esters, phosphonic acids or their esters, sulfonates, carboxyl groups, amino groups, hydroxyl groups, urethane groups, isocyanate groups, and capped isocyanate groups.

The curing agents used are preferably compounds that represent chemical antipodes to the corresponding reactive groups of the resin. Examples of such compounds are:
Compounds selected from the group consisting of β-hydroxyalkylamides, such as Primid XL 552 supplied by Ems-Primid, Switzerland
Compounds based on glycidyl functions such as triglycidyl isocyanurate (known as TGIC), for example, Araldit PT 810 or Araldit PT910 supplied by Huntsman, Switzerland
Compounds based on capped and free isocyanates, such as Vestagon BF 1540 supplied by Degussa, or Vestagon BF 1530
Epoxy curing agents based on organic salts such as Vestagon B31 supplied by Degussa, Germany.
Curing agents subject to stimulation by radiation, such as IRGACURE 2959 and IRGACURE 819 supplied by Ciba Specialty Chemicals, Switzerland.
Resins having groups complementary to the aforementioned resins.
amine curing agents

The metallic pigments used are preferably commercially available aluminum, copper, brass (golden bronzes), iron, zinc, titanium, nickel, and interference pigments having a metal core and/or a metallic coating.

The pigments can be uncoated but may alternatively be primed, i.e., they can have additional protective layers. These may be barrier layers such as SiO₂ or polymeric, highly cross-linked polymer layers. Such primed metallic pigments have potentially an even higher degree of corrosion stability. Examples of such pigments are PCR (SiO₂ coating, supplied by Eckart, Fuerth, Germany), PCA polymer coating (supplied by Eckart) or PCF polymer coating (supplied by Toyal, Japan).

Furthermore, metallic pigments having a colored coating, for example, pigments coated with iron oxide such as the Paliocrom® products (supplied by BASF AG, Ludwigshafen, Germany), can be used as starting pigments for the manufacture of the pigments of the invention.

Surprisingly, oxidized metallic effect pigments, such as aluminum pigments oxidized by a chemical wet process, can alternatively be used as starting pigments. A chemical wet-process oxidation can be used to color aluminum pigments.

Metal oxide coatings, which impart additional attractive color tones to the metallic pigments, can be created in copper and brass pigments by oxidation in the air at elevated temperatures.

For example, attractive golden yellow pigments can be created by specific chemical wet-process oxidation of aluminum pigments, according to the method disclosed in EP 0 848 735, which is included herein by reference. These golden yellow pigments are marketed by Eckart GmbH & Co. KG of Fuerth, Germany, under the brand name of Aloxal®.

In chemical wet-process oxidation, a highly hydrated aluminum oxide/hydroxide layer is formed around the aluminum core. Hitherto, it has not been possible to use such chemical wet-process oxidized pigments in a powder-based varnish, because it has not been possible to reproducibly obtain a high quality coating by the application of a powder-based varnish containing a chemical wet-process oxidized aluminum pigment to the surface of a substrate. In the case of the metallic pigments of the invention, the surface of the coated pigments is aligned with the surface of the binding agent particles in the powder-based varnish. It is thus perfectly possible to apply a powder-based varnish containing metallic pigments of the invention based on chemical wet-process oxidized aluminum pigments to the surface of a substrate at a reproducible quality level.

The metallic pigments of the invention can also be interference pigments that have a metal core coated by poorly refractive dielectric layers and highly refractive metal oxide or metallic layers. Pigments marketed under the brand names Variocrom® (BASF AG) or Chromaflair® (Flex Products, Inc.) are examples of pigments that may be used for this purpose.

In a development of the invention, it is possible to prime the metallic pigment with a substance that improves the adhesion between the metallic pigment surface and the binding agent coating. These primer coatings can be, say, functionalized silanes, functionalized polymers, and organophosphoric compounds. These compounds can also be deposited on the supplementary coating.

Preference is given to functionalized silanes.

The silanes used for this purpose preferably have the general formula (I)

(Y)R(_{4-z})Si(X)_{z} (I)

In the silane compound of formula (I), z is an integer from 1 to 3, R is a substituted or an unsubstituted, unbranched or branched alkyl chain having 1 to 12 C atoms, Y is a functional group that can react with corresponding binding agent functionalities, and X represents a halogen group and/or an alkoxy group. R can also be cyclically bonded to Si, in which case z is usually 2.

The silanes bind to the metallic pigment surface following a condensation reaction of the Si(X) grouping with the surface OH groups of the metallic pigment surface. On the other hand, the reactive function Y can effect binding to the subsequently deposited oligomeric and/or polymeric binding agent. These bonds may be covalent bonds or weaker interactions such as hydrogen bridge bonds. It is important that the oligomeric and/or polymeric binding agent be anchored to the metallic pigment surface by the silane functioning as an adhesion promoter with a sufficient degree of firmness so that it mostly remains bonded to the metallic pigment in the solvent dispersion prior to spraying. The silanes therefore act as adhesion promoters between the metallic pigment surface and the oligomeric and/or polymeric binding agent in the coating.

Preference is given to isocyanate, epoxy, amino, hydroxy, carboxy, acrylate, or methacrylate groups as functional groups Y. These groups react with corresponding chemically compatible counterpart groups of the oligomeric/polymeric binding agent. During this process, however, the binding agent as such does not cure completely. In other words, the oligomeric/polymeric binding agent retains its chemical cross-linkability or curability. The functional group Y of the silane can react, for example, with functional groups of the oligomeric/polymeric binding agent that do not take part, or only partially take part, in the curing of the oligomeric/polymeric binding agent. The functional group of the oligomeric/polymeric binding agent can, for example, be present in a stoichiometric excess relative to the functional group Y of the silane. On the metallic pigment surface primed with at least one silane compound of formula (I), the functional groups (Y) are always present in a stoichiometric deficit relative to the corresponding chemically compatible functional counterpart group of the subsequently deposited oligomeric and/or polymeric binding agent.

For example, Y can thus be an isocyanate, whereas the binding agent comprises polyester components having polyol and polycarboxy functions. At room temperature, the isocyanate groups can react with OH groups of the binding agent, possibly in the presence of a catalyst. It is only after the metallic pigment has been coated and incorporated in a varnish system that the polyester coating cures completely during stoving of the varnish system. The group Y is preferably a terminal group, as the highest degree of reactivity occurs in a terminal group on account of the least degree of sterical hindrance. However, it can also be a near-terminal group with up to 3 C atoms being present between the Y function and the end of the chain.

The binding agent functionalities that react with Y can optionally be the same as those that synthesize the polymer during curing of the binding agent. As already explained above, this is possible because the oligomeric/polymeric binding agent functional groups reactive with Y are always present in a stoichiometric excess relative to the functional group Y on the pigment surface, so that after the reaction of the reactive group Y with the oligomeric/polymeric binding agent has taken place, enough functional groups will still remain on the oligomeric and/or polymeric binding agent for cross-linking or curing to take place. The oligomeric/polymeric binding agent functional group that is reactive with the reactive group Y can optionally be different from the functional group(s) involved in the curing of the binding agent.

Organofunctional silanes suitable as surface modifying agents having the corresponding functional groups are commercially available. Examples of such silanes are the many representatives of the products manufactured by Degussa in Rheinfelden and marketed under the brand name of Dynasylan®D, the Silquest® silanes manufactured by OSi Specialties, and the GENOSIL® silanes manufactured by Wacker.

Specific examples include methacryloxypropyltrimethoxysilane (Dynasylan MEMO, Silquest A-174NT), 3-mercaptopropyltri(m)ethoxysilane (Dynasylan MTMO or 3201; Silquest A-189), 3-glycidoxypropyltrimethoxysilane (Dynasylan GLYMO, Silquest A-187), tris(3-trimethoxysilylpropyl) isocyanurate (Silquest Y-11597), gamma-mercaptopropyltrimethoxysilane (Silquest A-189), beta-(3,4-epoxycyclohexyl)ethyltrimethoxysilane (Silquest A-186), gamma-isocyanatopropyltrimethoxysilane (Silquest A-Link 35, Genosil GF40), (methacryloxymethyl)trimethoxysilane (Genosil XL 33), isocyanatomethyl)trimethoxysilane (Genosil XL 43), aminopropyltrimethoxysilane (Dynasylan AMMO; Silquest A-1110), aminopropyltriethoxysilane (Dynasylan AMEO) or N-(2-aminoethyl)-3-aminopropyltrimethoxysilane (Dynasylan DAMO, Silquest A-1120) or N-(2-aminoethyl)-3-aminopropyltriethoxysilane, triamino-functional trimethoxysilane (Silquest A-1130), bis(gamma-trimethoxysilylpropyl)amine (Silquest A-1170), N-ethyl-gamma-aminoisobytyltrimethoxysilane (Silquest A-Link 15), N-phenyl-gamma-aminopropyltrimethoxysilane (Silquest Y-9669), 4-amino-3,3-dimethylbutyltrimethoxysilane (Silquest Y-11637), (N-cyclohexylaminomethyl)triethoxysilane (Genosil XL 926), (N-phenylaminomethyl)trimethoxysilane (Genosil XL 973), and mixtures thereof.

The silanes, preferably silanes of formula (I), can be deposited directly on the metallic surfaces of metallic pigments. According to a preferred development, the metallic pigments are provided with an SiO₂ coating and preferably enveloped by a SiO₂ coating, the silanes being deposited on said SiO₂ coating. The oligomeric and/or polymeric binding agent is then deposited on the metallic pigment thus primed.

In a development of the invention, organic or inorganic colored pigments, as well as coloring agents, can be present in the coating so that colored metallic pigments are accessible. By this means it is possible, in particular, to produce colored effect pigments showing a high degree of corrosion stability:
(a) Colored pigments
i) organic colored pigments
Organic colored pigments include commercially available pigments of the monaozo, bisazo, anthraquinone, phthalocyanine blue, phthalocyanine green, perylene, perinone pigments, indigo, thioindigo, indolinone, isoindolinone pigments, quinacridone, pyrrolopyrrolidone, dioxazine pigment classes, and metal complex pigments such as copper azomethine yellow, as well as other classes and pigments listed by Herbst and Hunger in Industrielle org. Pigmente, VCH Verlagsgesellschaft mbH, Weinheim, Germany (1987).
ii) inorganic colored pigments
Inorganic colored pigments include iron oxide pigments, lead chromate pigments, chromium oxide pigments, ultramarine pigments, complex inorganic colored pigments, iron blue pigments, cadmium pigments, bismuth vanadate pigments, cerium sulfide pigments, and commercially available titanium dioxide and zinc sulfide white pigments, as well as other classes and pigments listed by Hartmut Endriss in ‘Aktuelle anorg. Buntpigmente’, Vincentz-Verlag.
(b) Dyes
Examples of migration-stable dyes that are suitable for use are heavy metal salts complexed with azoligands, and organometallic compounds that have at least one azo group and/or chromophoric group and are soluble in the medium being used, such as Solvent Yellow 79, Solvent Red 8, Solvent Blue 45 and Solvent Black 45, available from Clariant, Basel, Switzerland.

In a development of the invention, corrosion inhibitors can also be present in the coating. These corrosion inhibitors can have either an anodic or a cathodic effect and may optionally be mixed. Corrosion stabilizing pigments can also be used as corrosion inhibitors. Examples thereof are strontium zinc phosphosilicate, zinc aluminum polyphosphate hydrate, zinc calcium aluminum strontium phosphate silicate hydrate, zinc calcium strontium orthophosphate silicate hydrate, strontium aluminum polyphosphate hydrate, calcium aluminum polyphosphate silicate hydrate and sodium and/or calcium and/or zinc molybdate and/or phosphomolybdate and/or zinc phosphate complex, or mixtures thereof.

Preference is given to corrosion stabilizing pigments having a mean particle size ranging from 0.1 μm to 10 μm and preferably from 0.15 μm to 5 μm.

Corrosion stabilization can also be imparted or improved by priming the metallic pigments with silicon dioxide, metallic oxide, organophosphate compounds and preferably with phosphoric acid esters and/or phosphoric acid compounds, and/or polymers.

In another development of the invention, other standard varnish and powder-based varnish additives can also be present in the coating, so that the metallic pigments of the invention have custom-made application properties in the application medium.

Preference is given to supplementary agents selected from the group consisting of additives, fillers, degassing agents, film-forming agents, flame-retardant agents, adhesion promoters, corrosion inhibitors, light-stabilizing agents, flatting agents, photoinitiators, polymerization inhibitors, polymerization initiators, radical interceptors, anticaking agents, slip agents, radiation curing reactive thinners, thermally cross-linkable reactive thinners, UV absorbers, leveling agents, cross linking catalysts, waxes, and mixtures thereof.

The metallic pigments of the invention can also be used in conjunction with other pigments in coating compositions, in a master batch, or a powder-based varnish. According to a preferred embodiment, the metallic pigments of the invention can be used in conjunction with pearl gloss pigments. Pearl gloss pigments cannot corrode and are therefore suitable for coatings that are subjected to corrosive conditions such as natural weathering. Mixtures of metallic pigments of the invention and pearl gloss pigments are thus suitable for powder-based varnish systems used for powder-based varnish coatings of, say, facade elements, vehicle bodies, vehicle frames, etc.

The binding agent content in the metallic pigments of the invention is preferably from 20% to 85% by weight, preferably from 52% to 75% by weight and more preferably from 55% to 60% by weight, always based on the total weight of the coated metallic pigment.

The binding agents preferably do not polymerize or do not substantially polymerize during coating or following coating of the metallic pigments. Polymerization of the binding agents surrounding the metallic pigments preferably does not take place before stoving of the finished varnish after the metallic pigments of the invention have been added to the application medium. In this case thermal polymerization takes place.

However, curing by UV or IR radiation can also take place in the case of binding agents which polymerize via free-radical polymerization. In this case, both the binding agent in the varnish and the binding agent in the coating can polymerize, the binding agent in the varnish preferably cross-linking with the binding agent in the coating.

A major advantage of the metallic pigments of the invention is, inter alia, the much improved bonding of the metallic pigments to the binding agent in the varnish. This is achieved in particular if the same binding agent is used for coating the pigments as is used as the application medium.

On account of their flake-like structure, metallic pigments are always likely to spoil the coating of varnish and thus impart reduced mechanical stability to the coating or the film of varnish. The metallic pigments of the invention, however, can be oriented almost perfectly in the coating as the latter cures, the result of which is increased mechanical and chemical stability of the coating.

Thus cured powder-based varnishes in which metallic pigments of the invention are present are found to have a considerably better abrasion stability, in particular, than traditional powder-based varnish coatings. Surprisingly, cured powder-based varnish coatings of the invention have a novel and attractive effect. A substrate surface coated with the powder-based varnish of the invention gives the observer the lo impression of metal having spatial depth. It is believed that good bonding of the metallic pigments to the powder-based varnish coating accounts for these advantageous properties. The metallic pigments of the invention have a content of metallic pigments exhibiting leafing characteristics either to a negligible extent or not at all.

It has been found, surprisingly, that the pigments enveloped by binding agents of the invention can also be used as a master batch in the powder-based varnish. In a master batch, the binding agent content preferably ranges from 50% to 85% by weight, more preferably from 55% to 80% by weight and very preferably from 60% to 75% by weight.

Master batches are usually used in plastics materials. In this case, a master batch is a highly pigmented synthetic material that is added to the plastics material composition in the extruder.

In a powder-based varnish, a metallic pigment manufactured by the traditional bonding method represents a kind of preform of a master batch. With metallic pigments, however, pigmentation levels of merely about 8% are the maximum that can be achieved.

Substantially higher metallic pigment concentrations can be achieved with the coated metallic pigments of the invention, so that one can truly speak of a master batch in this case. This is particularly true of the case in which the metallic pigment is coated with the same binding agent system, say, a powder-based varnish, in which the metallic pigment will later also be incorporated and processed.

In the present invention, it is most advantageously possible to prepare a master batch or a coating composition having a metal content preferably of from 0.5% to 15% by weight, more preferably from 1% to 12% by weight and very preferably from 2% to 8% by weight, always based on the total weight of the master batch or the coating composition.

The high pigmentation level of the master batch and of the coating composition as is made possible by the present invention opens up completely new possibilities. The use of highly pigmented or highly concentrated master batches is a major advantage with regard to, for example, transportation. On account of the higher concentration of the master batch, smaller quantities are required to give the same end concentration of, say, a powder-based varnish, and consequently, only smaller quantities need be transported.

In a coating composition, the higher concentration of metallic pigments makes it possible to achieve better coverage of a substrate to be coated with metallic pigments than is possible with traditional powder-based varnish systems.

Furthermore, the object of the invention is achieved by the provision of a process for the manufacture of a metallic pigment according to any one of claims 1 to 26. This process includes the following steps:
a) preparing a solution or dispersion of an oligomeric and/or polymeric binding agent in an organic solvent,
b) coating the metallic pigment with said binding agent by:
   i) dispersing the metallic pigment in the solution or the dispersion produced under a) and subsequently atomizing the same, or
   ii) spraying the solution or the dispersion produced under a) onto a metallic pigment fluidized in a gas stream,
c) drying the metallic pigment coated with the binding agent in a turbulent gas stream.

Obviously the metallic pigments can alternatively be initially dispersed in an organic solvent and then the oligomeric and/or polymeric binding agent can be added, either in dissolved or undissolved form, thus producing a dispersion of metallic pigments and binding agent or binding agent solution, which dispersion will then be atomized in step b)i).

Preferred developments of the process of the invention are given in the subordinate claims. The statements made with respect to the metallic pigments or the coating composition of the invention also apply analogously to the explanation of the process of the invention.

The metallic pigments are insoluble in the organic solvent and form a dispersion with the solvent or with the compounds dissolved in the solvent. The binding agents and possibly other additives and/or agents used, say, curing agents, are preferably soluble in organic solvents. However, they can also be present as dispersions if they are insoluble in the organic solvents.

Preference is given to the addition of other additives and/or agents to the oligomeric and/or polymeric binding agent dissolved or dispersed in the solvent, prior to bringing the binding agent into contact with the metallic pigments.

The additives and/or agents preferred for use have already been listed above. In the incorporation of said additives and/or agents in a solution or a dispersion of polymeric or oligomeric binding agents, preference is given to a homogeneous distribution of said additives and/or agents in the coating applied to the metallic pigments.

The additives and/or agents can include, for example, curing agents, photoinitiators, and/or polymerization initiators. Furthermore, the additives and/or agents can include corrosion inhibitors, preference being given to corrosion stabilizing pigments. The additives and/or agents have already been listed in detail above.

Water, organic solvents, or hydrated organic solvents can be used as solvents. Preference is given to organic solvents having a water content preferably of less than 2% by weight, more preferably of less than 1% by weight and very preferably of less than 0.5% by weight. The percentages by weight given herein are based on the total weight of the solvent being used.

In another preferred embodiment of the process of the invention, binding agents which show affinity toward the pigments can be used in the coating of the metal pigments. Binding agents that show affinity toward the pigment are to be understood as binding agents which have groups that act as adhesion promoters and which bind to the metallic pigment while it is still in the pigment/binding agent dispersion. Examples of such agents include epoxide resins, epoxide resin-modified phosphoric acid esters, such as Resydrol VAX 5538w/50 WA supplied by UCB Surface Specialities, carboxy-functionalized resins, phosphonate-functionalized resins, phosphonic acid ester-functionalized resins, and sulfonate functionalized resins. Such resins bind to the surface of the metallic pigment while the pigment is still dispersed in a solvent.

When using silanization agents, such as the aforementioned silanization agents, said agents are preferably deposited on the surface of the metallic pigments in the same organic solvent as is used to produce the solution or the dispersion of the oligomeric and/or polymeric binding agent. Silanization of the metallic pigments can be achieved by shaking or stirring at elevated temperatures, as well as with the optional addition of water and/or a catalyst. Preference is given to slightly volatile organic bases such as ammonia, slightly volatile amines, etc. as catalysts.

An improved coating quality with fewer spherical secondary precipitations is obtained during subsequent spraying of the metallic pigment dispersion. It is believed that extensive priming of the metallic pigments with binding agents prior to spraying results in an improved coating with the remaining binding agent that has not yet become bonded to the metallic pigment. The priming already achieved in the dispersion by the binding agents showing pigment affinity could cause a type of nucleation, which might promote the smooth coating to an even greater degree while the dispersion is being sprayed.

The removal of the solvent or the drying of the coated metallic pigments is preferably achieved by simultaneously or subsequently fluidizing the coated metallic pigments.

Fluidization of the coated metallic pigments effectively prevents any aggregation or agglomeration of the metallic pigments. Since the metallic pigments in an applied coating of varnish function in a manner comparable to numerous minute mirrors, an agglomeration of the metallic pigments should be avoided in order not to impair the optical appearance of the coating.

Preference is given to combining steps (bi) and (c) in a first variant of the process in that the spraying of the coated metallic pigments and the removal of the solvent is achieved by spray drying.

The residual moisture of the dried metallic pigments of the invention is preferably less than 4% by weight, more preferably less than 2% by weight and very preferably less than 1.2% by weight, always based on the total weight of the metallic pigment of the invention. Higher residual moisture contents can make the surfaces of the coated pigments sticky, which has the drawback of causing undesired agglomeration and/or aggregation.

Spray drying is a particularly cost-favorable drying method that simultaneously assures high throughputs. A batch operation mode as well as a continuous operation mode is possible with spray drying. Preference is given to spray drying methods for the manufacture of the metallic pigments of the invention.

In spray drying, the dispersion is atomized or nebulized into an enclosed space in the unit under a suitable spray pressure. The spray pressure is adjusted relative to external conditions such as the solids content, the viscosity of the dispersion to be sprayed, the temperature in the reactor, the type of solvent, etc., and it can be readily determined by a person skilled in the art. Preference is given to atomization in a gas stream of, say, air or nitrogen. On account of the high degree of increase in surface area, the droplets that form result in a high degree of evaporation of the solvent, which can be further improved by increasing the temperature of the carrier air. To this end, the temperature is selected such that there is no substantial polymerization or curing of the reactive coating on the metallic pigments.

In spray drying, nebulization can be achieved with centrifugal nebulizers, such as nebulizer discs or nebulizer wheels, with pressure nozzles, two substance nozzles or spin nozzles. The gas stream can flow through the unit in either co-current or counter-current mode. With spray drying in a mixed flow pattern, the nozzles are mounted in the lower section of the drying tower, wherein the spray is directed upwardly like a fountain. The separation of the product from the gas stream takes place under the spray tower and is achieved by a cyclone and a filter. Furthermore, a combined method involving a so-called fluidized spray dryer can be used to dry the suspension to be sprayed. This method combines the advantages of spray drying of fine droplets with fluidized bed drying. Obviously, other spray drying methods can be used, if desired.

According to another preferred embodiment, steps (bii) and (c) are combined in that coating and drying of the metallic pigments take place in a fluid bed or a fluidized bed, in which the oligomeric and/or polymeric binding agents dissolved or dispersed in the solvent are injected, and the solvent is removed during fluidization in the fluid bed or the fluidized bed.

This variant of the method is the same as a fluid bed coating. To this end, the pigment is introduced into an enclosed spray drying apparatus and fluidized by blowing in pressurized air or pressurized nitrogen. The volume of pressurized air or pressurized nitrogen is selected such that a calm and non-turbulent surface is produced. The binding agent solution or dispersion is then passed through a nozzle and sprayed into the agitated fluid bed. The solvent can then be removed as in the first variant of the process, for example, by subjection to heat, and the metallic pigment of the invention can then be dried.

The pigment/binding agent/solvent dispersion for spray drying, or the binding agent solution or dispersion for fluid bed coating can be manufactured, for example, with the following organic solvents: alcohols, ethers, esters, ketones, as well as aliphatic and aromatic hydrocarbons having a boiling point below 130° C. Particular preference is given to acetone and ethyl acetate. However, mixtures of the aforementioned organic solvents can be used. Water or water-solvent mixtures can also be used.

The dispersion is preferably sufficiently fluid so that it can be sprayed through a nozzle without any difficulty. Preference is given to a solvent content of the dispersion of from 50% to 97% by weight, preferably of from 50% to 85% by weight and more preferably of from 50% to 75% by weight, always based on the total weight of the dispersion.

The pressure at which the pressurized air or nitrogen is introduced into the apparatus is preferably from 1 to 5 bar and more preferably from 2 to 4 bar.

The temperature for evaporating the solvent is substantially dependent on the nature of the solvent. Preference is given to temperatures ranging from 0 to 130° C., and particular preference is given to temperatures ranging from 20 to 80° C.

The temperature is preferably selected such that the solvent evaporates well and the binding agent coating does not polymerize to any great extent and preferably does not polymerize at all. Slight polymerization of the binding agent, however, is not forbidden and is not significant as long as sufficient reactivity of the binding agent still remains.

The metallic pigment of the invention manufactured according to both variants of the process is a free-flowing, low-dust powder having a d₅₀ particle size which is smaller than 190 μm and preferably smaller than 100 μm. Preference is given to a d₅₀ particle size of at least 5 μm. Thus the metallic pigment is not granular. Granules have a particle size that is generally in the millimeter range.

After the manufacturing process, the metallic pigment of the invention can be separated or sifted in order to assure a defined particle size distribution of the product.

The metallic pigment powder of the invention can be treated with a suitable fluid phase, preferably a solvent, so that it can be prepared as a paste. The pigment content of the paste is preferably from 30% to 80% by weight, based on the total weight of the paste.

The solvents used for producing a paste are preferably water or organic solvents such as aliphatic hydrocarbons (white spirit), aromatic hydrocarbons (solvent naphtha), alcohols, esters, ketones, aldehydes, ethers, or mixtures thereof.

For this purpose, only solvents that do not release the binding agent from the metallic pigment should be used. Preference is given to aliphatic and/or aromatic hydrocarbons.

The coated metallic pigments of the invention are preferably used in the manufacture of paints, varnishes, powder-based varnishes, printing inks, plastics materials, and cosmetics.

The following examples and figures explain, but do not limit, the invention.

### EXAMPLE 1

125 g of a saturated polyester having an acid value of 70 (Crylcoat 340, supplied by UCB, Belgium) and 125 g of an epoxy resin having an epoxy equivalent weight of 750 (Araldit GT 6063 ES, supplied by Vantico, Switzerland) were dissolved in 1800 g of acetone, and 250 g of Standart Spezial PCR 501 (d₅₀=20 μm) (available from Eckart of Fuerth, Germany) were stirred in. 2300 g of the dispersion were sprayed into a spray dryer at a rate of 30 g/min and at a spray pressure of 2.5 bar in a hot air stream having a temperature of 55° C. The yield was 483 g of pigment.

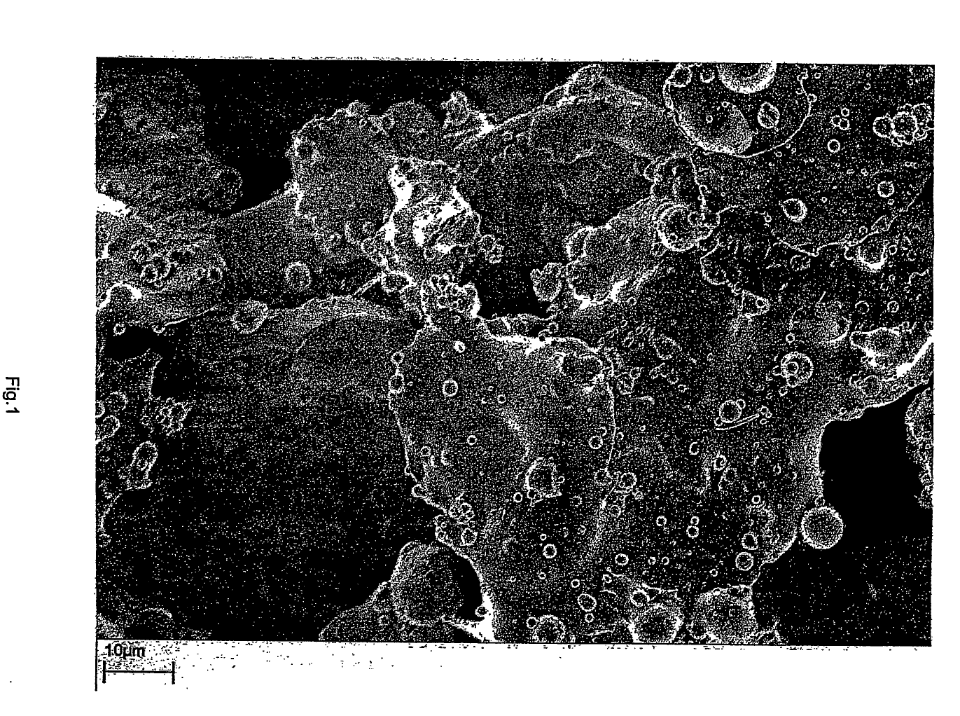

FIG. 1 shows a scanning electron microscopic image of the coated metallic pigment of Example 1 of the invention.

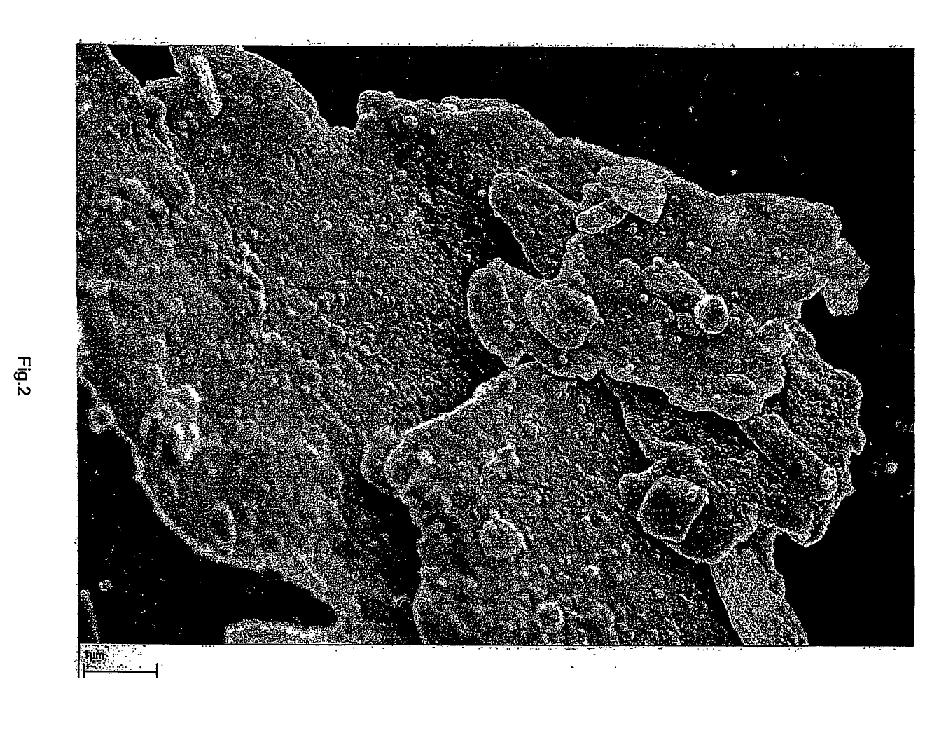

FIG. 2 shows the starting pigment (Comparative Example 6).

The comparison of these two figures shows that the metallic pigment of the invention is completely enveloped by the coating of binding agent.

### EXAMPLE 2

125 g of a saturated polyester having an acid value of 70 (Crylcoat 340, supplied by UCB, Belgium) and 125 g of an epoxy resin having an epoxy equivalent weight of 750 (Araldit GT 6063 ES, supplied by Vantico, Switzerland) were dissolved in 1800 g of acetone, and 300 g of Dorolan Reichbleichgold 10/0 (supplied by Eckart) were stirred in. 2300 g of the dispersion were sprayed into a spray dryer at a rate of 30 g/min and at a spray pressure of 2.5 bar in a hot air stream having a temperature of 55° C. The yield was 537 g of pigment.

### EXAMPLE 3

125 g of a saturated polyester having an acid value of 70 (for example, Crylcoat 340, supplied by UCB, Belgium) and 125 g of an epoxy resin having an epoxy equivalent weight of 750 (for example, Araldit GT 6063 ES, supplied by Vantico, Switzerland) were dissolved in 1800 g of acetone, and 50 g of Standart Spezial PCR 501 were stirred in. 2100 g of the dispersion were sprayed into a spray dryer at a rate of 30 g/min and at a spray pressure of 2.5 bar in a hot air stream having a temperature of 55° C. The yield was 288 g of pigment.

### EXAMPLE 4

Example 1 was repeated, except that Standart 212 (d₅₀=50 μm; Eckart) was used as the aluminum pigment. This pigment was not primed.

### COMPARATIVE EXAMPLE 5

Commercially available STANDART aluminum powder Spezial PCR 501 (Eckart).

### COMPARATIVE EXAMPLE 6

Commercially available STANDART golden bronze powder Dorolan Reichbleichgold 10/0 (Eckart).

### COMPARATIVE EXAMPLE 7

Commercially available STANDART PCA 501 (d₅₀=20 μm) (Eckart).

### COMPARATIVE EXAMPLE 8

Commercially available PCF 7130 (d₅₀=20 μm; supplied by Toyal, Japan). This is an aluminum pigment with a three dimensionally cross-linked polymer layer (polymerized from monomers).

### COMPARATIVE EXAMPLE 9

Commercially available Standart Aluminumpigment 212 (STAPA® Metallux 212; d₅₀=50 μm) (Eckart) in dry form.

### Example 10

Example 1 was repeated, except that commercially available Aloxal 3010 (d₅₀=18 μm, Eckart) was used as the starting material.

### COMPARATIVE EXAMPLE 11

Commercially available Aloxal 3010 (d₅₀=18 μm, Eckart), which was dried but with no additional coating being applied. The applications described below showed an uneven spray pattern.

The following conformity checks show the improved stabilities of the coated metallic pigments of the invention in the application (single layer varnish coating, i.e., with no clear varnish layer):
Test for resistance to various acids and bases
Condensation water/constant climate test (according to DIN 50017)
Mortar test according to GSB (Gütegemeinschaft für die Stückbeschichtung von Bauteilen e.V. [Quality Association for Piece Coating of Structural Elements], Schwaebisch-Gmuend, D-73525, Germany) stipulations

In a test for resistance to various acids and bases, test plates were coated with the powder-based varnishes of the various examples or comparative examples of the invention, as described below, and exposed to drops of various concentrations of hydrochloric acid and sulfuric acid, and sodium hydroxide. The drops were allowed to react for from 5 minutes to three hours on the respective plate. After the acids or bases had been washed off, the degree of gray discoloration of each drop area was rated according to the following criteria:
0 points=no corrosion
1 point=barely discernible corrosion
2 points=clearly discernible corrosion
3 points=complete gray discoloration

A total rating ranging from 0-42 points was calculated from a total of 14 drop areas.

The GSB [Quality Association for Piece Coating of Structural Elements] mortar test was performed on test plates coated with pigmented facade coatings (powder-based varnish). In accordance with the stipulations of AAMA 603-7-1976 or AAMA 2604-98 (AAMA: American Architectural Manufacturers Association), a defined quantity of limestone mortar was applied to a test plate. The test plate was then immediately exposed to a relative humidity of 100% at a temperature of 40° C. for 24 hours.

In order to pass this test, it must be possible, after 24 hours, to easily remove the mortar from the coated surface and easily remove any residues with a damp cloth. Furthermore, there must be no evidence of a loss of adhesiveness in the powder-based varnish film and no discernible alteration in the appearance of the surface upon examination with the naked eye. This test is an exceptionally rigorous chemical test, because the pH values in wet mortar usually range from 11-12. As a rule, a high degree of an unpleasant gray discoloration of the stressed surface is produced in single layer varnish coatings containing aluminum pigments. Nevertheless, a metallic appearance of the varnish coating that at least approximates the undamaged state should be evident. On aluminum pigments, in particular, this test places stringent requirements which have yet to be fulfilled by the commercially available systems.

The mortar test is rated visually, and the degree of gray discoloration of the weathered zone is evaluated in the examples on a scale of 0 to 5, according to the system described in DIN 53230. The standard reference is the unweathered plate zone or an unweathered plate.

| Rating no. | Key |
|---|---|
| 0 | no alterations |
| 1 | traces of gray discoloration |
| 2 | slight gray discoloration |
| 3 | medium degree of gray discoloration |
| | (metallic flakes are still recognizable) |
| 4 | high degree of gray discoloration |
| | (metallic flakes are hardly recognizable) |
| 5 | very high degree of gray discoloration |

For the stress tests, powder-based varnishes were applied in a commercially available polyester/Primid system (available from DuPont, Essenbach, Germany). The pigmentation levels in the examples of the invention were initially 5% or 10% by weight of coated metallic pigment and thus 2.5% and 5% by weight, respectively, based on the aluminum content. The comparative examples were only pigmented to an extent of 1% by weight. As a rule, such low pigmentation levels produce better results in stress tests, because in this case the binding agent of the coating improves the stability of the metallic pigments.

TABLE 1
Results of the durability tests

| | | Condensation | | |
|---|---|---|---|---|
| | Chemical test | water/constant | | GSB |
| Sample | Rating | climate (DIN 50017) | | mortar test |
| Example 1 | 0 | >1,000 | h | 1 |
| Example 2 | 3 | >1,000 | h | 1 |
| Example 3 | 0 | >1,000 | h | 1 |
| Example 4 | 4 | >1,000 | h | 2-3 |
| Comp. Ex. 6 | 24 | 72 | h | 5 |
| Comp. Ex. 7 | 31 | 500 | h | 4 |
| Comp. Ex. 8 | 15 | 108 | h | 4 |
| Comp. Ex. 9 | 3 | >1,000 | h | 3 |
| Example 10 | 0 | >1,000 | h | 1 |
| Comp. ex. 11 | 3 | >1,000 | h | 4 |

The results show that applications of the coated pigments of the invention suffer noticeably less damage from acids and bases than applications of traditional pigments.

Analogously, applications of the coated pigments of the invention show substantially greater durabilities in the condensation water/constant climate test than applications of traditional metallic pigments.

In the mortar test, all traditional aluminum pigments tested hitherto have shown considerable alterations in the appearance of the surface, i.e., a gray discoloration having the circumference of the mortar deposit. This was also true of Comparative Example 9, which did very well in the other stress tests.

Alterations to the surface are hardly discernible in the coated metallic pigments of the invention of Examples 1 to 3. The coated aluminum pigments of the invention therefore pass this test and thus fulfill an important requirement for use in powder-based varnishes for facade systems, for example, facade tiles.

The advantageous recyclability of the coated metallic pigments of the invention for powder-based varnish applications is shown after the varnishes had been cycloned three times. Whereas the application of traditional metallic pigments (Comparative Example 6) after cycloning showed considerable color alterations on account of partial demixing of the metallic pigments and the powder-based varnish, no changes could be discerned in the application of the coated metallic pigments of the invention.

In addition to the metallic gloss, the cured powder-based varnishes containing metallic pigments of the invention give an observer the impression that such coatings have an unusual spatial depth. Furthermore, the cured powder-based varnishes of the invention have an exceptional abrasion stability. The abrasion stability can be confirmed, for example, by the so-called “Tesa test,” wherein an adhesive strip is stuck to a varnished substrate surface and then pulled off. No varnish is detached with a cured powder-based varnish of the invention.

Another advantage of the coated metallic pigments of the invention is shown in their improved processing characteristics during powder coating. On account of the very different electrostatic charging properties of the metallic pigment and the powder-based varnish binding agent, agglomerations form in the spray gun. This leads to the formation of lumps of pigment in the spray application. This lump formation is visually rated according to the following scale given in DIN 53 230:

Rating of 0: no lump formation

Rating of 1: first visually discernible lump formation

Rating of 2: low degree of lump formation

Rating of 3: medium degree of lump formation

Rating of 4: high degree of lump formation

Rating of 5: very high degree of lump formation

For the purposes of comparison, a very large aluminum pigment, which as a rule is difficult to bond, was tested. The uncoated aluminum pigment of Comparative Example 9 was applied as a dry blend and as a bonded powder-based varnish. On the other hand, Example 4 of the invention was applied as a simple dry blend.

Results:

Example 4: 0-1

Comparative Example 9 as a dry blend: 3

Comparative Example 9 bonded: 1-2

Substantially improved application is thus achieved with the coated aluminum pigment of the invention, even as a simple dry blend preparation, than with the bonded aluminum pigment which had not been primed with the binding agents according to this invention.

For use in wet varnish systems, gassing tests were performed under identical conditions on the commercially available Mischlacksilber (supplied by BASF, Wuerzburg) water-based varnish system, wherein the resulting quantity of hydrogen was measured in each case. The test is considered as passed if less than 22 ml of hydrogen gas are produced after 30 days.

Example 1: 12 ml after 30 days

Comparative Example 6: >19 ml after 2 days

In the case of Comparative Example 6, the test was terminated after two days because the degree of hydrogen development was too great.

1. Metallic pigments with a coating,
characterized in that
the coating envelops the metallic pigments and comprises at least one of an oligomeric and a polymeric binding agent, which binding agent is at least one of chemically cross-linkable and cross-linkable under the action of means selected from the group consisting of heat, infrared radiation, ultraviolet radiation and electron radiation, which coated metallic pigments are present in the form of a powder which has a particle size d50 of less than 190 μm and are resistant to corrosion following curing in a powder-based varnish.

2. Metallic pigments as defined in claim 1,
characterized in that
the particle size d50 of the coated metallic pigments ranges from 5 μm to 100 μm.

3. Metallic pigments as defined in claim 1,
characterized in that
said metallic pigments contain from 20 to 85% by weight of at least one of an oligomeric and a polymeric binding agent, based on the total weight of the coated metallic pigments.

4. Metallic pigments as defined in claim 1,
characterized in that
the coating contains, in addition to said binding agent, at least one of further additives and auxiliaries.

5. Metallic pigments as defined in claim 4,
characterized in that
the at least one of additives and auxiliaries comprise comprises at least one of organic and inorganic colored pigments and dyes.

6. Metallic pigments as defined in claim 4,
characterized in that
the at least one of additives and auxiliaries comprises at least one of curing agents, photoinitiators and polymerization initiators.

7. Metallic pigments as defined in claim 4,
characterized in that
the at least one of additives and auxiliaries are varnish components, selected from the group consisting of fillers, degassing agents, film-forming auxiliaries, flameproofing agents, adhesion promoters, light-stabilizing agents, flatting agents, polymerization initiators, radical interceptors, anticaking agents, slip agents, radiation-hardening reactive diluents, ultraviolet absorbers, flow-control agents, cross-linking catalysts, and waxes.

8. Metallic pigments as defined in claim 1,
characterized in that
the metallic pigments are primed, prior to application of said coating with binding agent, or with an additional, layer or with a plurality of additional layers.

9. Metallic pigments as defined in claim 8,
characterized in that
the metallic pigments are primed with at least one of silicon dioxide, metal oxide, organophosphoric compounds and polymers.

10. Metallic pigments as defined in claim 8,
characterized in that
the metallic pigments are primed with adhesion promoters for the binding agent coating.

11. Metallic pigments as defined in claim 1,
characterized in that
the binding agent(s) is/are selected from the group consisting of polyester resins, epoxide resins, polyurethane resins, UV-curing systems, acrylates, and mixtures thereof.

12. Metallic pigments as defined in claim 11,
characterized in that
the polyester resins are selected from the group consisting of saturated polyester resins containing OH groups and having a hydroxyl number between 30-150 mg of KOH/g, saturated carboxyl group-containing polyester resins having an acid value between 25-70 mg of KOH/g, and mixtures thereof.

13. Metallic pigments as defined in claim 11,
characterized in that
the epoxide resins are selected from the group of those having more than one epoxide ring.

14. Metallic pigments as defined in claim 11,
characterized in that
the polyurethane resins are selected from the group consisting of OH-functional polyester resins, polyacrylate resins with at least one of blocked and unblocked polyisocyanates, and mixtures thereof.

15. Metallic pigments as defined in claim 11,
characterized in that
the UV-curing systems are compounds having at least one of mono-unsaturated and polyunsaturated double bonds.

16. Metallic pigments as defined in claim 6, characterized in that
the curing agent is selected from the group consisting of hydroxyalkylamine-containing compounds, glycidyl group-containing compounds, epoxy group-containing compounds, triglycidyl isocyanurates, and mixtures thereof.

17. Metallic pigments as defined in claim 1,
characterized in that
cross-linking of the binding agent(s) and of any curing agent present is thermally inducible.

18. Metallic pigments as defined in claim 1,
characterized in that
the coating containing binding agent contains corrosion inhibitors.

19. Metallic pigments as defined in claim 18,
characterized in that
the corrosion inhibitors are at least one of anodic and cathodic corrosion inhibitors.

20. Metallic pigments as defined in claim 18,
characterized in that
the corrosion inhibitors are corrosion-stabilizing pigments selected from the group consisting of strontium zinc phosphosilicate, zinc aluminum polyphosphate hydrate, zinc calcium aluminum strontium phosphatesilicate hydrate, zinc calcium strontium orthophosphatesilicate hydrate, strontium aluminum polyphosphate hydrate, calcium aluminum polyphosphatesilicate hydrate, sodium molybdate, sodium phosphomolybdate, calcium molybdate, calcium phosphomolybdate, zinc molybdate, zinc phosphomolybdate, zinc phosphate complex, and mixtures thereof.

21. Metallic pigments as defined in claim 18,
characterized in that
the corrosion-stabilizing pigments have a mean particle size ranging from 0.1 to 10 μm.

22. Metallic pigments as defined in claim 1,
characterized in that
the metallic pigments are selected from the group consisting of aluminum, copper, iron, titanium, nickel, zinc, and brass pigments, and mixtures thereof.

23. Metallic pigments as defined in claim 1,
characterized in that
the metallic pigments are oxidized metallic pigments.

24. Metallic pigments as defined in claim 1,
characterized in that
the metallic pigments are chemically wet-process oxidized aluminum pigments.

25. Metallic pigments as defined in claim 1,
characterized in that
the metallic pigments are metal-containing interference pigments having at least one of a metal core and a metal coating.

26. Metallic pigments as defined in claim 1,
characterized in that
the powder exists as a paste in conjunction with a liquid phase.

27. A masterbatch for powder-based varnishes,
characterized in that
the masterbatch contains metallic pigments as defined in claim 1.

28. A coating composition,
characterized in that
the coating composition contains metallic pigments as defined in claim 1, which metallic pigments are resistant to corrosion following curing of the coating composition.

29. A coating composition as defined in claim 28,
characterized in that
the coating composition contains a powder-based varnish.

30. A coating composition as defined in claim 28, characterized in that
the coating composition has a metal content of from 0.5% to 15% by weight, based on the total weight of the coating composition.

31. A coating composition as defined in claim 30,
characterized in that
the coating composition has a metal content of from 2% to 8% by weight.

32. A coating composition as defined in claim 29,
characterized in that
the powder-based varnish and the coating of the metallic pigments contain the same binding agent.

33. A coated object,
characterized in that
the object is coated with metallic pigments as defined in claim 1.

34. A coated object as defined in claim 33,
characterized in that
the object is a facade element, a window frame, a vehicle body, or a frame of a vehicle.

35. A process for the production of a metallic pigment as defined in claim 1, comprising the steps of:
a) preparing a solution or dispersion of at least one of an oligomeric and a polymeric binding agent in an organic solvent,
b) coating the metallic pigment with said binding agent either by
i) dispersing the metallic pigment in the solution or dispersion produced in step a) followed by atomization thereof, or
ii) atomizing the solution or dispersion produced in step a) onto metallic pigments fluidized in a gas stream, and
c) drying the metallic pigments coated with binding agent in a turbulent gas stream.

36. A process for the production of a metallic pigment as defined in claim 35, characterized in that the metallic pigments coated with binding agent are, following step c), additionally subjected to size classification.

37. A process as defined in claim 35,
characterized in that
at least one of further additives and auxiliaries are added to the at least one of a oligomeric and polymeric binding agent dissolved or dispersed in solvent.

38. The process as defined in claim 37,
characterized in that
the at least one of additives and auxiliaries are selected from the group consisting of curing agents, photoinitiators and polymerization initiators.

39. The process as defined in claim 37,
characterized in that
the at least one of additives and auxiliaries are selected from the group consisting of corrosion inhibitors and corrosion-stabilizing pigments.

40. The process as defined in claim 35, characterized in that
the solvent used is selected from the group consisting of water, an organic solvent, and a water-containing organic solvent.

41. The process as defined in claim 35, characterized in that
the steps (bi) and (c) are combined in that atomization of the coated metallic pigments and the elimination of the solvent is carried out by spray drying.

42. The process as defined in claim 35, characterized in that
the steps (bii) and (c) are combined in that the coating and drying of the metallic pigments is carried out in a fluid bed or a fluidized bed in that the at least one of an oligomeric and a polymeric binding agent dissolved or dispersed in the solvent is spray injected and the solvent is removed by turbulent mixing in the fluid bed or the fluidized bed.

43. A method of preparing a material selected from the group consisting of paints, varnishes, powder-based varnishes, printing inks, plastics materials, and nail varnish, comprising adding to said material the metallic pigment as defined in claim 1.

44. A method of preparing a highly durable powder-based varnish for coating facades, comprising including in said varnish the metallic pigment as defined in claim 1.

45. A nail varnish, characterized in that
it contains metallic pigments as defined in claim 1.

46. Metallic pigments as defined in claim 8, wherein said at least one additional layer is cross-linked.

47. Metallic pigments as defined in claim 9, wherein said metal oxide organophosphoric compounds are selected from the group consisting of phosphates and phosphoric acid compounds.

48. Metallic pigments as defined in claim 10, wherein the adhesion promoters are selected from the group consisting of functionalized silanes, functionalized polymers and organophosphorous compounds.

49. Metallic pigments as defined in claim 48 wherein said organophosphorous compound is selected from the group consisting of phosphate esters and phosphoric acid compounds.

50. Metallic pigments as defined in claim 13, wherein the epoxide resins have an epoxy equivalent weight (EEW) of from 400 to 2500.

51. Metallic pigments as defined in claim 23, wherein said oxidized metallic pigments are selected from the group consisting of oxidized copper and oxidized brass pigments.

52. Metallic pigments as defined in claim 26, wherein said liquid phase comprises an organic solvent.

53. A coated object, characterized in that, the object is coated with a coating composition as defined in claim 28.

54. A process as defined in claim 37, characterized in that said at least one of further additives and auxiliaries are added prior to contact of said at least one of a oligomeric and polymeric binding agent with the metallic pigments.
